(19) United States
(12) Patent Application Publication
(10) Pub. No.: US 2008/0184771 A1
(43) Pub. Date: Aug. 7, 2008

(54) Gen-X posi-count automatic tilt/tip-over bottle liquid pour counter

(76) Inventor: Hassan Abdulla Ebrahim, Lexington, SC (US)

Correspondence Address: Hassan A. Ebrahim, 223 Hallmark Drive, Lexington, SC, 29072, US

(21) Appl. No.: 11/701,920

(22) Filed: Feb. 2, 2007

(51) Int. Cl. G01B 21/00

(52) U.S. Cl. 73/1.79

(57) ABSTRACT

The restaurant and bar industry is in dire need for an easy, affordable and efficient way of counting bottled liquid inventory. Gen-X Posi-Count Automatic Tilt/Tip-Over Bottled Liquid Pour Counter is an automatic counter that counts, records and displays each time a bottle is tilted or tipped over to the point of which the liquid is poured, for the purpose of keeping an accurate count of how many drinks or pours are supplied out of each bottle. Gen-X Posi-Count Automatic Tilt/Tip-Over Bottled Liquid Pour Counter is equipped with a tilt/tip-over switch that counts the tilts/tip-overs from 1 to 9999 tilts/tip-overs. The device is equipped with a reset button when pushed, is reset to 0. The device is equipped with a push button light that when pressed it illuminates the four digit display for viewing the recorded count in a dark environment. The device attaches to the subject liquid bottle and counts, records and displays each time the bottle is tilted or tipped over to the pouring position.

I claim priority to a U.S. Provisional Patent Application Ser. No. 60/756,162 filed on Jan. 4, 2006

### BACKGROUND

Previously and presently the restaurant and bar industry when it comes to selling alcohol or wine in the method of free-pour out of a big bottle, free-pour meaning the staff is in control of how much liquor or wine is poured, rely 100 percent on their staff as far as accuracy and accountability is concerned. Some restaurants and bars use scales, tape measures, electronic transmittal devices, cameras, etc. to resolve the problem of accuracy and accountability.

### SUMMARY

Gen-X Posi-Count Automatic Tilt/Tip-Over Bottled Liquid Pour Counter solves this problem by recording each time a bottle is tilted or tipped over to the pouring position. Having the pours counted and recorded into a number of pours displayed provides the restaurant or bar owner with a way to accurately count and inventory free-pour sales and

### Summary Continued

identify the under-trained ff. Gen-X Posi-Count Automatic Tilt/Tip-Over Bottled Liquid Pour Counter when placed on a bottle would result in 100 percent accountability of the liquid in that bottle without changing the pouring method. Each time a pour occurs the counter automatically counts one pour and by knowing the volume of the inventory in the bottle and the number of pours, clarifies how much liquid was poured each time. Ultimately, without the involvement of any other method of liquid inventory counting Gen-X Posi-Count Automatic Tilt/Tip-Over Bottled Liquid Pour Counter when applied properly, will produce a very easy way to count inventory and reveal common mistakes and errors made by the pouring staff.

### SPECIFICATIONS

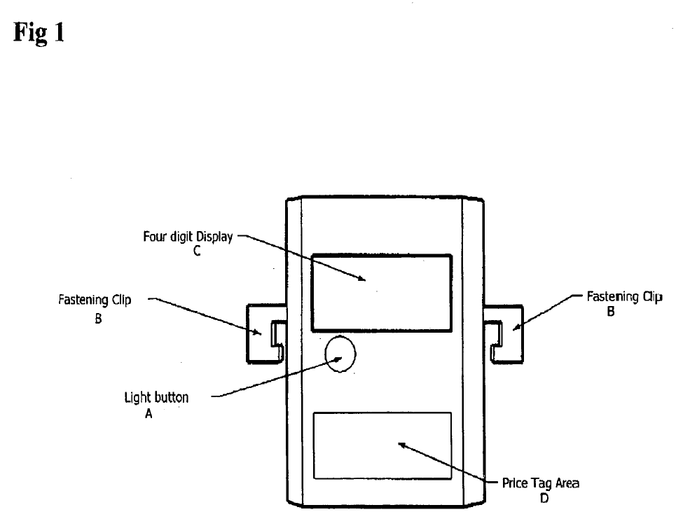

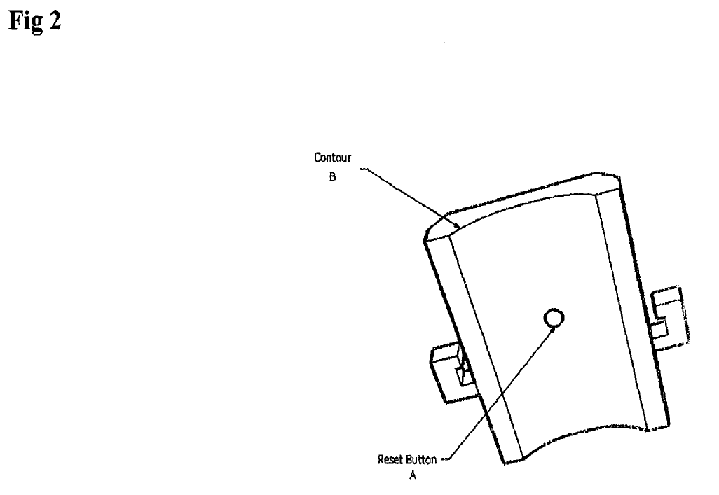

Gen-X Post-Count Automatic Tilt/Tip-Over Bottled Liquid Pour Counter is a 23 mm×19 mm×7 mm device. The device uses the technology that consists of a digital event counter with a four digit display (See FIG. 1 C) that counts from 1 to 9999 and a mercury tilt/tip-over switch. The backside of the device is contoured (See FIG. 2 B) for the purpose of placing the device securely on bottles or bottle necks. The sides of the device are two clips for the purpose of fastening the device securely onto bottles or the bottle necks (See FIG. 1 B). The device detects each time it is tilted or tipped over to the portion of pouring, then it counts one pour and displays it on the digit) for digit display. The device is equipped with a reset button (See FIG. 2 A) that can be reset to 0 at any time, otherwise it counts up to 9999 before it automatically returns to 0. The device is equipped with a light, the button for this light is on the front of the device (See FIG. 1 A) when the button is pressed it will illuminate the four digit display for viewing the recorded count in a dark environment. The device is batty operated; it uses a replaceable one button cell SR54, HG10 or equivalent battery with an approximate life of one year. The device can be labeled to the price per pour of the liquid in the bottle it is counting (See FIG. 1 D).

I claim:

1. Gen-X Posi-Count Automatic Tilt/Tip-Over Bottled Liquid Pour Counter counts each pour out of any liquid bottle that is tilted or tipped over for pouring such as, liquor, wine, juice, etc.

2. Gen-X Posi-Count Automatic Tilt/Tip-Over Bottled Liquid Pour Counter records the counted pours out of any liquid bottle that is tilted or tipped over for pouring such as, liquor, wine, juice, etc.

3. Gen-X Posi-Count Automatic Tilt/Tip-Over Bottled Liquid Pour Counter displays the recorded count out of any liquid bottle that is tilted or tipped over for pouring such as, liquor, wine, juice, etc.

4. Gen-X Posi-Count Automatic Tilt/Tip-Over Bottled Liquid Pour Counter of claim number 3 wherein the device displays the number of times liquid inventory is poured.

5. Gen-X Posi-Count Automatic Tilt/Tip-Over Bottled Liquid Pour Counter of claim number 4 wherein the device accurately displays the amount of times liquid inventory is sold.

6. Gen-X Posi-Count Automatic Tilt/Tip-Over Bottled Liquid Pour Counter of claim number 5 wherein the device when applied properly will produce a way to reveal common inventory mistakes and errors made by the pouring staff.
